(19) United States
(12) Patent Application Publication
(10) Pub. No.: US 2014/0041538 A1
(43) Pub. Date: Feb. 13, 2014

(54) E-Compactor

(71) Applicant: Vijay Parmar, Langenburg (CA)

(72) Inventor: Vijay Parmar, Langenburg (CA)

(21) Appl. No.: 13/964,276

(22) Filed: Aug. 12, 2013

Related U.S. Application Data
(60) Provisional application No. 61/682,511, filed on Aug. 13, 2012.

(51) Int. Cl. B65F 1/14; B30B 3/04; B30B 5/06; B30B 9/32

(52) U.S. Cl. CPC B65F 1/1405; B30B 9/325; B30B 3/04; B30B 5/067
USPC 100/152; 100/173; 100/174; 100/264

(57) ABSTRACT

A compacting device is disclosed that is an at-home compactor for a variety of recyclable containers. The compacting device comprises a pair of opposing side units, wherein each of the opposing side units comprises a plurality of rollers secured together, creating a compacting zone. Typically, the plurality of rollers are secured together via a conveyor belt, and the surface of the conveyor belt would comprise a textured surface which creates friction to direct a recyclable container downward through the compacting zone. Furthermore, the compacting device comprises a storage unit for collecting the compacted recyclable containers, and a push component that assists with the downward movement of the recyclable containers through the compacting zone. The compacting device also comprises a selector component that funnels different types of recyclable containers into separate storage units, and a lid which acts to seal the contents of the compacting device and prevent leaks.

### CROSS-REFERENCE

This application claims priority from Provisional Patent Application Ser. No. 61/682,511 filed Aug. 13, 2012.

### BACKGROUND

Without a convenient way to compact recyclable products at home, the full-sized bottles and cans begin to build up into a cluttered mess. Individuals must then make frequent trips to the recycling center for the bottles and cans, in order to get rid of clutter and clean up their home. These frequent trips create a waste of time and money for the homeowner. Further, manual compacting and sorting by the consumer can be difficult, time-consuming and potentially dangerous, especially when working with the sharp surfaces of, for example, aluminum cans. Therefore, since recycling can be inconvenient, homeowners may choose to throw more products out, increasing the waste in landfills. Further, lack of efficiency at recycling centers cost taxpayers and private recycling companies more money to complete the recycling process. Thus, an at-home compactor for individual use is necessary.

The present invention can conveniently compact virtually any type of recyclable container at home, including plastic soda bottles, milk jugs, and aluminum cans. The compacting device saves users valuable time, space and money by reducing the volume of each recyclable container and therefore reducing the storage space necessary in the home. Users will be able to compact their recyclables regularly in order to collect more recyclables before making a trip to the recycling center. By saving storage space, the homeowner will have less clutter around the home or garage, and will save time and fuel by having to make fewer trips during the year to the recycling center. Further, by making the recycling process more efficient, convenient and cost-effective, this device can also encourage and strengthen environmentally-friendly habits in consumers.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a compacting device that is an at-home compactor for a variety of recyclable containers. The compacting device comprises a pair of opposing side units, wherein each of the opposing side units comprises a plurality of rollers secured together, creating a compacting zone. Typically, the plurality of rollers are secured together via a conveyor belt, and the surface of the conveyor belt would comprise a textured surface which would create enough friction to direct a recyclable container downward into and through the compacting zone to be compacted by the rollers.

The plurality of rollers can be stationary, and do not move translational to each other to reduce the need for moving parts, or if more effective, the plurality of rollers can compress slightly inward to help create the necessary friction needed to move the recyclable containers through the compacting zone. Furthermore, the compacting device comprises a storage unit for collecting the compacted recyclable containers. Thus, the recyclable containers move through the plurality of rollers and into the compacting zone, and then once compacted by the rollers, the recyclable containers are deposited into the storage unit.

In a preferred embodiment, the compacting system comprises a push component that assists with the downward movement of the recyclable containers through the compacting zone. The push component is wedge-like in shape, and can be manually operated by a user, or can be operated automatically via an electric motor. Further, the compacting device comprises a selector component that funnels different types of recyclable containers into separate storage units. The selector component functions as a sliding lever that closes the funnel area on one side, so as to direct compacted recyclable containers into the desired storage unit. The compacting device can also comprise a lid and removable splash guard which acts to seal the contents of the compacting device and prevent leaks that may occur during compaction.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of the internal compacting component of the compacting device in accordance with the disclosed architecture.

FIG. 2 illustrates a perspective view of the push component within the compacting component of the compacting device in accordance with the disclosed architecture.

FIG. 3 illustrates a perspective view of the storage units of the compacting device in accordance with the disclosed architecture.

FIGS. 4 A-B illustrate a perspective view of the selector component of the compacting device in use in accordance with the disclosed architecture.

FIG. 5A illustrates a perspective view of the compacting device in a standalone configuration in accordance with the disclosed architecture.

FIG. 5B illustrates a perspective view of the compacting device in an under-mount configuration in accordance with the disclosed architecture.

FIG. 5C illustrates a perspective view of the compacting device in a garage unit configuration in accordance with the disclosed architecture.

FIGS. 6A-C illustrate a perspective view of another embodiment of the compacting device in use in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention can conveniently compact virtually any type of recyclable container at home, including plastic soda bottles, milk jugs, and aluminum cans. The compacting device saves users valuable time, space and money by reducing the volume of each recyclable container and therefore reducing the storage space necessary in the home. Users will be able to compact their recyclables regularly in order to collect more recyclables before making a trip to the recycling center. By saving storage space, the homeowner will have less clutter around the home or garage, and will save time and fuel by having to make fewer trips during the year to the recycling center. Further, by making the recycling process more efficient, convenient and cost-effective, this device can also encourage and strengthen environmentally-friendly habits in consumers.

The disclosed compacting device comprises a pair of opposing side units, wherein each of the opposing side units comprises a plurality of rollers secured together, creating a compacting zone. Typically, the plurality of rollers are secured together via a conveyor belt, and the surface of the conveyor belt would comprise a textured surface which would create enough friction to direct a recyclable container downward into and through the compacting zone. Furthermore, the compacting device comprises a storage unit for collecting the compacted recyclable containers, and a push component that assists with the downward movement of the recyclable containers through the compacting zone. The compacting device also comprises a selector component that funnels different types of recyclable containers into separate storage units, and a lid which acts to seal the contents of the compacting device and prevent leaks.

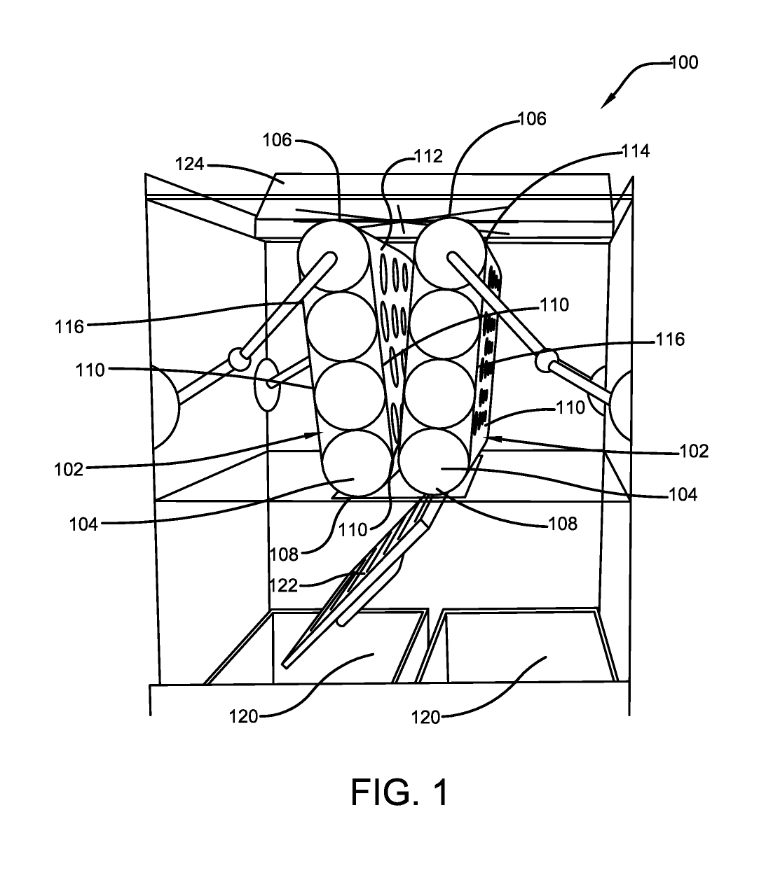

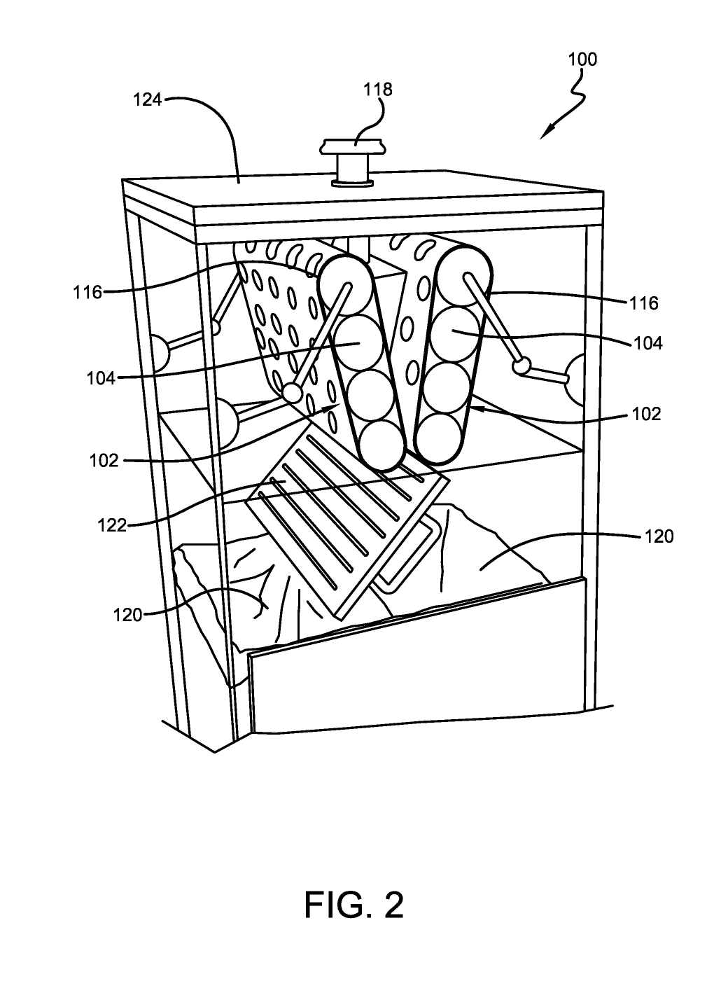

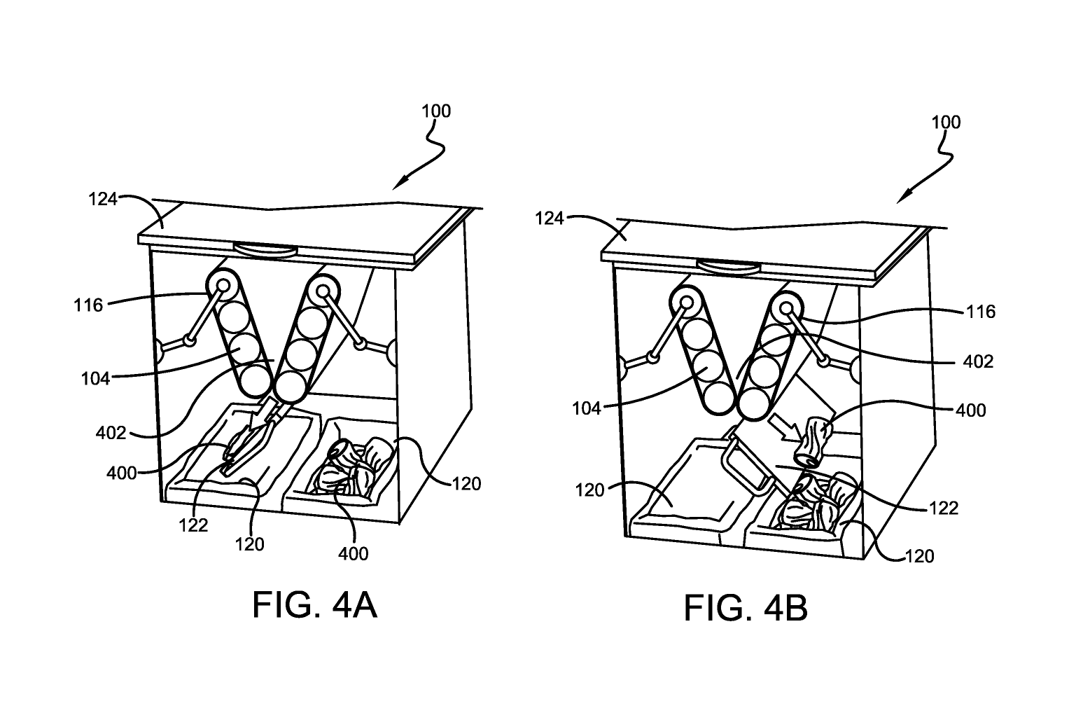

Referring initially to the drawings, FIGS. 1-2 illustrate the compacting device 100 that is an at-home compactor for a variety of recyclable containers 400 (as shown in FIGS. 4A-B). The compacting device 100 comprises a compacting component 101 comprising a pair of opposing side units 102, wherein each of the opposing side units 102 comprises a plurality of rollers 104 secured together, creating a compacting zone (as shown in FIG. 1).

The opposing side units 102 comprise a first end portion 106, a second end portion 108, and opposing sides 110. Typically, the opposing side units 102 can be any suitable shape as is known in the art without affecting the overall concept of the invention, such as cylindrical, oval, etc. (as shown in FIG. 2). The opposing side units 102 would generally be constructed of a plurality of rollers (or drums) 104 secured together, though any suitable number of rollers 104 can be used as is known in the art.

The rollers 104 are secured together creating a compacting zone, and would typically be constructed of metal, such as steel, aluminum, etc., though any other suitable material may be used to manufacture the rollers 104 as is known in the art without affecting the overall concept of the invention. Further, the surface of the rollers 104 would comprise a textured pattern, holes, teeth, etc., or any other suitable textured surface which would create enough friction to direct a recyclable container 400 downward into and through the compacting zone (i.e., the area where the recyclable containers 400 are compacted).

While the shape and size of the opposing side units 102 may vary greatly depending on the amount and size of the plurality of rollers 104 secured together, the opposing side units 102 are approximately between 14 and 20 inches long as measured from the first end portion 106 to the second end portion 108, and approximately between 14 and 20 inches wide as measured from opposing sides 110, and approximately between 2 and 4 inches thick as measured from a front surface 112 to a back surface 114.

Typically, the plurality of rollers 104 are secured together via a conveyor belt 116, or any other suitable chain or belt as is known in the art. The conveyor belt 116 would typically be constructed of metal or rubber, or any other suitable material as is known in the art, and the surface of the conveyor belt 116 would comprise a textured pattern, holes, teeth, etc., or any other suitable textured surface which would create enough friction to direct a recyclable container 400 downward into and through the compacting (or compaction) zone. The conveyor belt 116 also aids the rollers 104 in spinning in a common direction which helps direct the recyclable container 400 downward into and through the compacting zone. Specifically, as the rollers 104 spin, so would the conveyor belt 116, and thus would transport the recyclable container 400 through the narrow, but flexible compaction zone (approximately ¼ inch to 1 inch).

Additionally, the plurality of rollers 104 can be stationary (and do not move translational to each other) to reduce the need for moving parts, or if more effective, the plurality of rollers 104 can move. For example, the plurality of rollers 104 can compress slightly inward to help create the necessary friction needed to move the recyclable containers 400 through the compacting zone. If mobile, the plurality of rollers 104 are typically powered by an electric-motorized system, such as an electric motor with a chain or belt connected to the rollers 104, but can be powered by any other suitable system as is known in the art. Further, the compacting device 100 will not operate unless the lid/access draw 124 is completely closed which would prevent anyone from getting a hand or other item stuck in the compacting device 100, but an addition kill switch could also be incorporated.

Further, the compacting system 100 comprises a push component 118 that assists with a downward movement of the recyclable containers 400 through the compacting zone. The push component 118 is typically constructed of the same materials as the rollers (i.e., metal, such as steel, aluminum, etc.), though any other suitable material may be used to manufacture the push component 118 as is known in the art without affecting the overall concept of the invention. Additionally, the push component 118 is wedge-like in shape to help move the recyclable containers 400 down through the compacting zone. The push component 118 can be manually operated by a user, or can be operated automatically via an electric motor or other electric-motorized system. If operated via an electric motor, the push component 118 comprises a power, or on/off switch to operate.

The compacting device 100 further comprises at least one storage unit 120 for collecting the compacted recyclable containers 400. The storage unit 120 can be a solid structure or can be a garbage bag or other soft structure. The storage unit 120 can be any suitable size or shape as is known in the art, and can be constructed of any suitable materials as is known in the art, such as metal (i.e., aluminum or steel), or plastic, such as polyvinyl chloride (PVC), acrylonitrile butadiene styrene (ABS), or polycarbonate (PC). Further, any suitable number of storage units 120 can be employed depending on the wants and needs of a user. The recyclable containers 400 move through the plurality of rollers 104 and into the compacting zone, and then once compacted, the recyclable containers 400 are selectively deposited into a storage unit 120.

Further, the compacting device 100 comprises a selector component 122 that funnels different types of recyclable containers 400 into separate storage units 120. The selector component 122 can be any suitable size or shape as is known in the art, and can be constructed of any suitable materials as is known in the art, such as metal (i.e., aluminum or steel), or plastic, such as polyvinyl chloride (PVC), acrylonitrile butadiene styrene (ABS), or polycarbonate (PC). The selector component 122 functions as a sliding lever that closes the funnel area on one side, so as to direct compacted recyclable containers 400 into the desired storage unit 120. The selector component 122 can be manually operated or can be operated automatically via an electric motor or other electric-motorized system. The selector component 122 can be operated either by a manual slide or rotated in an automated manner via a container material sensor. The user would load the compacting device 100 with one type of material (recyclable container 400) at a time. For example, the user would load the compacting device 100 with multiple aluminum containers first, close the lid/drawer 124 and allow the containers 400 to be compacted and drop into the appropriate storage container 122. Then the user would use the appropriate switch to change to the plastic storage compartment 122 and then would load the compacting device 100 with multiple plastic containers, close the lid 124 and allow them to be compacted and drop into the plastic storage container 122. The user can repeat or alter the process as they feel necessary.

The compacting device 100 can also comprise an air freshener/sanitizer unit for controlling unpleasant odors. The air freshener/sanitizer unit can be placed on any suitable position on or in the compacting device 100 as is known in the art. The air freshener/sanitizer unit can be any suitable air freshener/sanitizer as is known in the art and functions as a typical prior art air freshener/sanitizer such that a user can change air freshener packets when the unit runs out, or replace the entire air freshener/sanitizer unit.

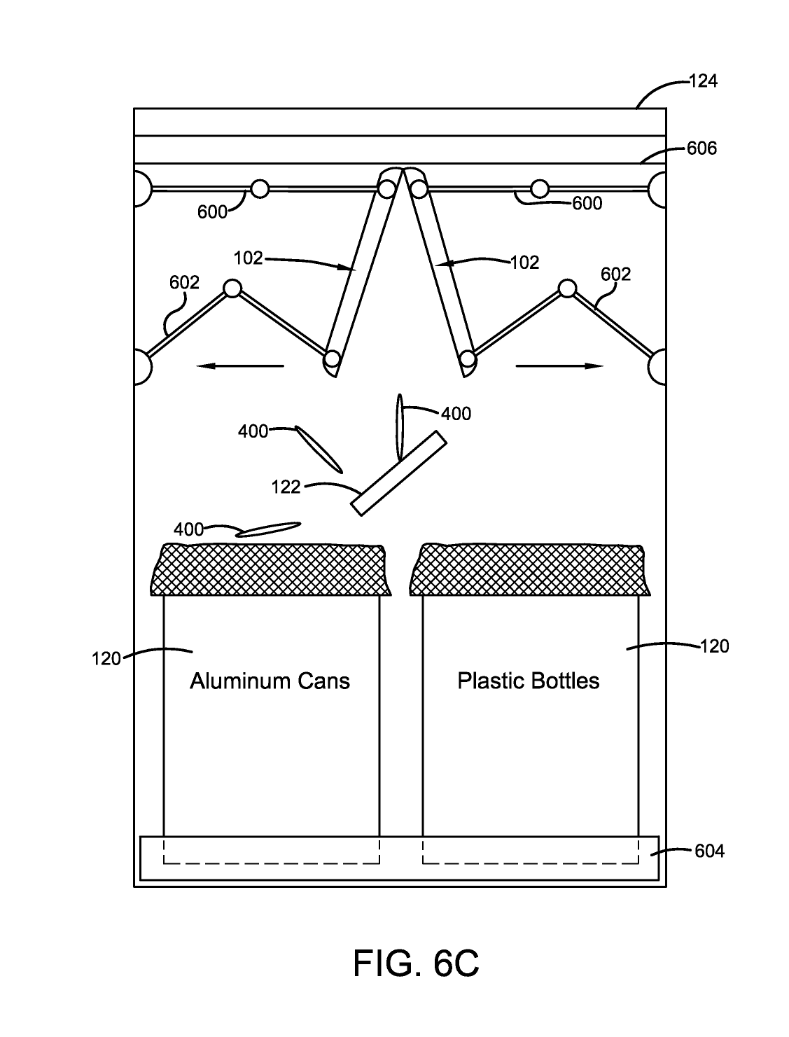

Further, the compacting device 100 can comprise a lid 124 which acts to seal the contents of the compacting device 100 and prevent leaks that may occur during compaction. Specifically, the lid 124 comprises a rubber seal, or other suitable seal around its perimeter which prevents liquids from leaking out of the compacting device 100. Additionally, the lid 124 can comprise a removable splash guard, which prevents leaks, but is removable to facilitate easy cleaning. The splash guard would be positioned around the perimeter of the lid 124 and would help to prevent any liquids from leaking from the compacting device 100. Furthermore, the lid 124 can comprise a security lock which prevents the compacting device 100 from operating when the lid 124 is open. For safety purposes, the compacting device 100 cannot operate unless the lid 124 is closed. Thus, it would automatically stop when the lid or drawer 124 is opened and will not operate unless the lid 124 is closed again. Further, washable mesh storage units/bags could be incorporated through which liquids could leak through into a drip tray 604 (as shown in FIGS. 6A-C), located underneath the storage bags.

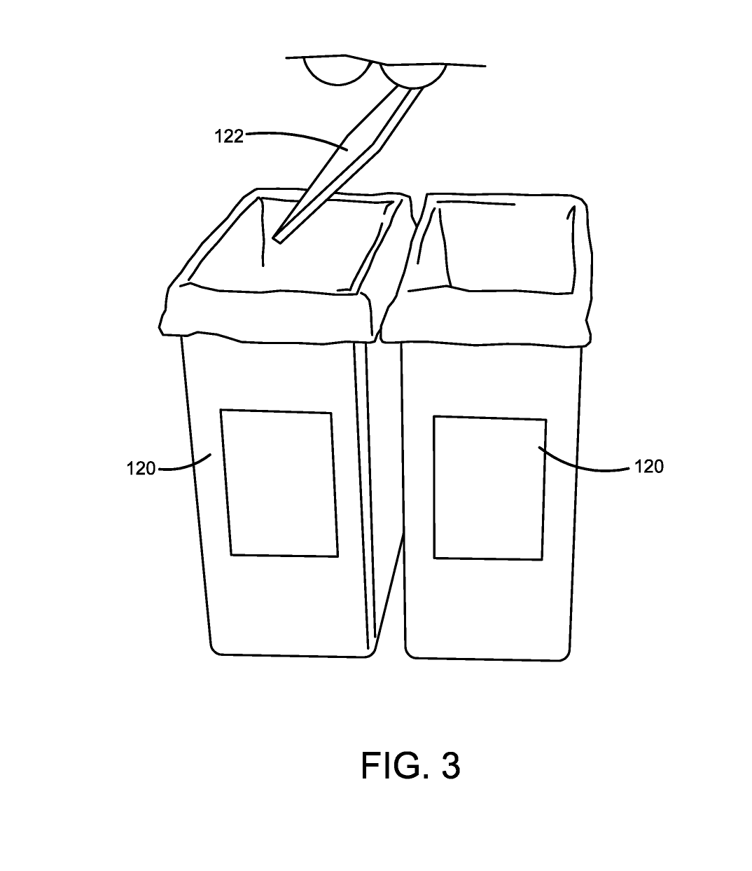

FIGS. 3 and 4A-B illustrate the storage units 120 and the selector component 122 of the compacting device 100 in use. As stated supra, the compacting device 100 comprises at least one storage unit 120 for collecting the compacted recyclable containers 400 (as shown in FIG. 3). The storage unit 120 can be a solid structure or can be a garbage bag or other soft structure. The storage unit 120 can be any suitable size or shape as is known in the art, and can be constructed of any suitable materials as is known in the art, such as metal (i.e., aluminum or steel), or plastic, such as polyvinyl chloride (PVC), acrylonitrile butadiene styrene (ABS), or polycarbonate (PC). Further, any suitable number of storage units 120 can be employed depending on the wants and needs of a user. In operation, the recyclable containers 400 move through the plurality of rollers 104 and into the compacting zone, and then once compacted by the rollers, the recyclable containers 400 are deposited into a storage unit 120. The rollers 104 only apply enough pressure to create the necessary friction to move the materials (recyclable containers 400) through the gradually narrowing compaction zone. Most recyclable containers 400 are made from plastics, aluminum, or cardboard, so the squeezing pressure created as the containers 400 move through the narrowing rollers 104 will compact the items into a flat, storage-friendly shape. This compacting device 100 is not meant for glass containers.

Further, the compacting device 100 comprises a selector component 122 that funnels different types of recyclable containers 400 into separate storage units 120 (as shown in FIGS. 4A-B). The selector component 122 can be any suitable size or shape as is known in the art, and can be constructed of any suitable materials as is known in the art, such as metal (i.e., aluminum or steel), or plastic, such as polyvinyl chloride (PVC), acrylonitrile butadiene styrene (ABS), or polycarbonate (PC). The selector component 122 functions as a sliding lever that closes the funnel area 402 on one side, so as to direct compacted recyclable containers 400 into the desired storage unit 120. The selector component 122 can be manually operated or can be operated automatically via an electric motor or other electric-motorized system.

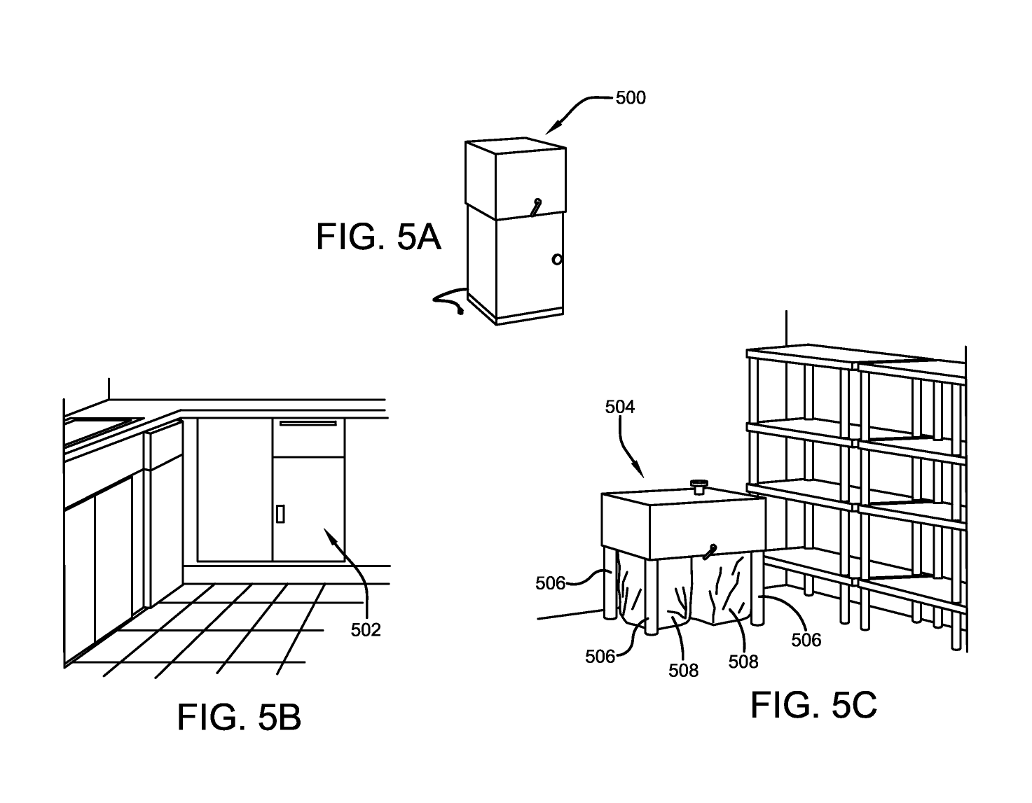

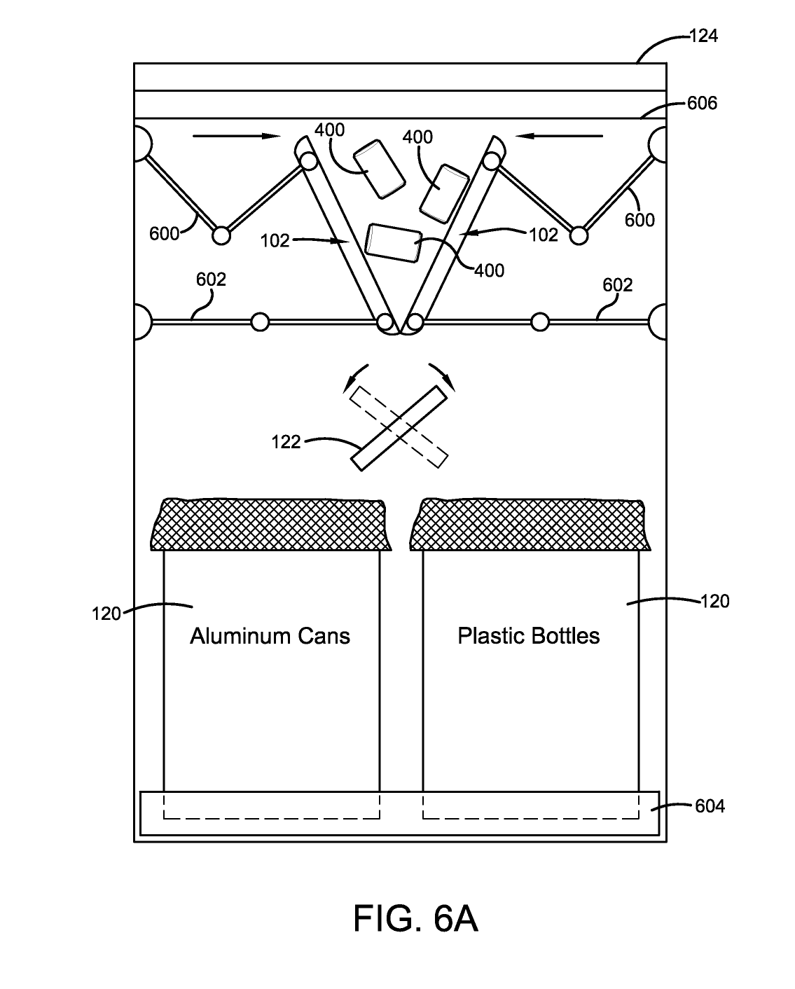

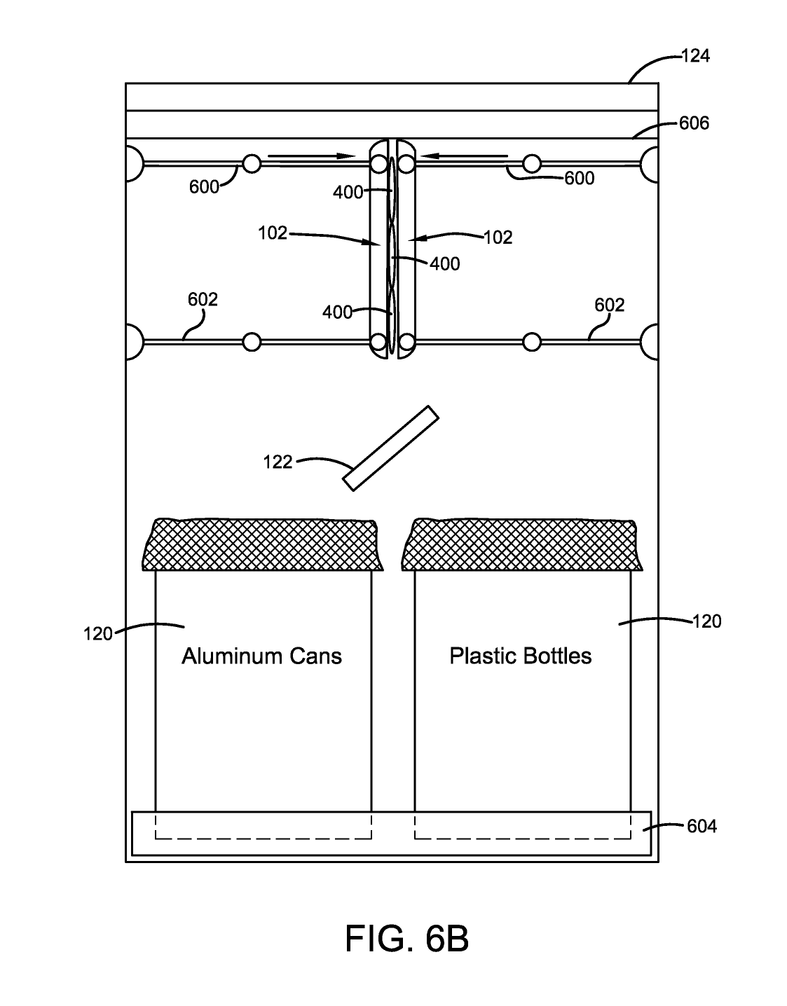

FIGS. 5 A-C illustrate the compacting device 100 in various configurations. For example, the compacting device 100 can be configured as a stand-alone unit 500 (as shown in FIG. 5A), or as an under-mounted unit 502 (as shown in FIG. 5B). The stand-alone 500 and the under-mounted units 502 could have stainless steel, black or white metal exteriors to match a user's kitchen decor. Further, the compacting device 100 can be configured as a garage unit 504 (as shown in FIG. 5C). The garage unit 504 can have legs 506 to support the compacting component 101 and can have an open area underneath where garbage bags 508 or other storage units 120 can be clipped into place to receive the compacted recyclable containers 400.

Overall, the compacting devices 100 comprise a combination of durable plastic and metal components, as well as storage areas and other compartments. Typically, the storage areas of the compacting devices 100 comprise air freshener/sanitizer units incorporated therein to avoid unpleasant odors. Further, the lid 124 can be rubber-sealed, with a removable splash guard to facilitate easy cleaning and to seal the contents of the compacting device 100 and prevent leaks that may occur during compaction. Additionally, the compacting device 100 comprises a safety latch (not shown). Thus, for safety purposes, the compacting device 100 cannot operate unless the lid 124 is closed. The compacting devices 100 can be constructed in a variety of shapes and sizes to suit user and manufacturing needs and preferences, though the compacting devices 100 should at least be large enough to accept traditional 4-liter plastic milk jugs.

FIGS. 6A-C illustrate another embodiment of the compacting device 100 utilizing a different method of compaction. The compacting device 100 comprises a pair of opposing side units 102 each with a compacting plate, which are secured together, creating a compacting zone (as shown in FIGS. 6A-C). Once the recyclable containers 400 are placed in the compacting device 100, the lid 124 is secured, and the splashguard 606 acts to prevent any leaks or spilling. At the beginning, the pair of opposing side units 102 are compressed together only at the bottom ends via a pair of bottom (jointed) arms 602 which extend to close and compact. In the start (or ready) position, the pair of opposing side units 102 form a “V-like” shape to hold the recyclable containers 400 in position (as shown in FIG. 6A). Once the recyclable containers 400 are loaded into the device 100, the pair of top (jointed) arms 600 also extend to close and compact, crushing the recyclable containers 400 between the pair of opposing side units 102 (as shown in FIG. 6B). Once compacted, the pair of bottom arms 602 release, pulling the pair of opposing side units 102 apart at their bottom ends, and releasing the crushed containers 400 onto the selector component 122 and into the desired storage unit 120 (as shown in FIG. 6C). The device 100 then resets itself back to ready position for the next load of recyclable containers 400. The storage units 120 can comprise mesh bags (not shown) which allow liquids from the crushed containers 400 to drip through and into a drip tray 604, preventing leaks and spills.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A compacting device for compacting at least one recyclable container comprising:
a compacting component comprising a pair of opposing side units;
wherein each of the opposing side units comprises a plurality of rollers secured together, creating a compacting zone which acts to compact the at least one recyclable container; and
at least one storage unit for collecting the at least one compacted recyclable container; and
wherein a surface of the plurality of rollers creates enough friction to direct the at least one recyclable container downwards through the compacting zone and into the at least one storage unit.

2. The compacting device of claim 1, wherein the plurality of rollers of the opposing side units are secured together via a conveyor belt which allows the plurality of rollers to spin in a common direction, moving the at least one recyclable container through the compacting zone.

3. The compacting device of claim 2, wherein the plurality of rollers are held stationary and do not move translational to each other.

4. The compacting device of claim 2, wherein the plurality of rollers are powered by a motorized system and compress slightly inward to move the at least one recyclable container downward through the compacting zone.

5. The compacting device of claim 1, further comprising a push component that assists with a downward movement of the at least one recyclable container through the compacting zone.

6. The compacting device of claim 5, wherein the push component is manually operated.

7. The compacting device of claim 5, wherein the push component operates automatically.

8. The compacting device of claim 1, further comprising a selector component that funnels different types of recyclable containers into separate storage units.

9. The compacting device of claim 1, further comprising an air freshener unit for controlling odors.

10. The compacting device of claim 1, further comprising a lid with a removable splash guard.

11. A compacting device for compacting at least one recyclable container comprising:
a compacting component comprising a pair of opposing side units;
wherein each of the opposing side units comprises a plurality of rollers secured together via a conveyor belt which allows the plurality of rollers to spin in a common direction, moving the at least one recyclable container through a compacting zone, which acts to compact the at least one recyclable container;
at least one storage unit for collecting the at least one compacted recyclable container from the compacting zone; and
a push component that assists with a downward movement of the at least one recyclable container through the compacting zone.

12. The compacting device of claim 11, wherein the push component is manually operated.

13. The compacting device of claim 11, wherein the push component operates automatically.

14. The compacting device of claim 11, wherein the plurality of rollers are held stationary and do not move translational to each other.

15. The compacting device of claim 11, wherein the plurality of rollers are powered by a motorized system and compress slightly inward to move the at least one recyclable container downward through the compacting zone.

16. The compacting device of claim 11, further comprising a selector component that funnels different types of recyclable containers into separate storage units.

17. The compacting device of claim 11, further comprising an air freshener unit for controlling odors.

18. The compacting device of claim 11, further comprising a lid with a removable splash guard.

19. A compacting device for compacting at least one recyclable container comprising:
a compacting component comprising a pair of opposing side units;
wherein each of the opposing side units comprises a compacting plate secured to a top arm and a bottom arm;
wherein the top arms and bottom arms extend to close the compacting plates, compacting at least one recyclable container, then the bottom arms contract to release the at least one recyclable container; and
at least one storage unit for collecting the at least one compacted recyclable container once released from the compacting plates.

20. The compacting device of claim 19, further comprising a selector component that funnels different types of recyclable containers into separate storage units.
